(19) United States
(12) Patent Application Publication
(10) Pub. No.: US 2011/0179064 A1
(43) Pub. Date: Jul. 21, 2011

(54) METHOD OF AND SYSTEM FOR PROVIDING A PROXIMITY-BASED MATCHING NOTIFICATION SERVICE

(76) Inventor: Anthony Peter Russo, New York, NY (US)

(21) Appl. No.: 12/980,035

(22) Filed: Dec. 28, 2010

Related U.S. Application Data
(60) Provisional application No. 61/295,814, filed on Jan. 18, 2010.

(51) Int. Cl. G06F 17/30; H04W 64/00

(52) U.S. Cl. 707/769; 455/456.1; 707/803; 707/E17.014; 707/E17.044

(57) ABSTRACT

A method and system for registering users, along with their profiles and preferences, within a social networking framework. Users can enter search criteria to locate others having matching criteria. The search is executed to automatically notify registered users if they are within a selected proximity of other registered users or entities of interest to them. This is useful for meeting new people who are nearby and share interests and are carrying mobile communication devices such as cell phones, smart-phones, laptop computers, or tablet computing devices.

### CROSS-REFERENCE TO RELATED APPLICATIONS

This application is related to U.S. Provisional Patent Application No. 61/295,814 entitled “METHOD OF AND SYSTEM FOR PROVIDING A PROXIMITY-BASED MATCHING SERVICE”, filed Jan. 18, 2010, the contents of which are incorporated herein by reference thereto.

### BACKGROUND OF THE INVENTION

1. Field of the Invention

The invention relates to a method and system for providing a proximity-based matching notification service within a social networking framework.

2. The Prior Art

Social networking sites such as Facebook, MySpace and Twitter have become immensely popular ways to search for and communicate with other registered users. Sites such as Match.com allow users to find others with compatible profiles. The location-based services these companies offer include “geo-location stamping” of messages such that other users can be made aware of the locations of people in their social networks. However, none of these services filter based on proximity, and the matching criteria for a social network in this context is typically limited to those people in the user's specified social network. For example, U.S. Pat. No. 7,739,139 provides a way for users to share contact information based on similar interests, but does not use location or proximity as a basis for doing so. U.S. Pat. No. 7,089,805 can advise users of known contacts' locations, but cannot advise users of people outside their network, nor can it alert a user when someone is located within a predetermined range. The prior art in social networking has no way for a user to automatically be notified of strangers outside of the network based on proximity and the user's own interest in meeting those strangers. Furthermore, none of the prior art allows users to be alerted automatically to contacts within their network who suddenly come within a predetermined proximity range and are of interest to the user.

Proximity-based marketing, while indeed taking location into account, does not provide any user-controllable matching capability and is meant, instead, to notify the merchant or marketeer that a potential customer is near a store or kiosk. Typically this is initiated by a user by tapping a bluetooth-enabled device near a receiver controlled by the marketing entity, so the process is neither automatic nor are there predefined matching criteria for either party. Instead, the marketeers are notified manually by the user, the user makes the conscious decision to notify at or near the time of arrival, and the marketeer, eager to sell, does not employ any sort of matching criteria to the user, but rather accepts all users who show interest in the store, service or product. For example, U.S. Published Patent Application No. 2008/0005104 describes a system that matches a user and a merchant based on proximity and merchant settings, but is limited to consumer-merchant relationships and gives to the merchant complete control over establishing contact and filtering for interest, leaving the user no options whatsoever in this regard.

### SUMMARY OF THE INVENTION

Accordingly, it is an object of the present invention to provide a system for automatically notifying registered users if they are within the proximity of other registered persons or entities of interest to them.

It is a further object to provide notification to a user whether or not they have any prior knowledge of, or relationship with, that person or entity.

It is another object to allow all parties to exercise control over whether notifications are sent to another party or parties.

It is a further object to implement outsider proximity-based social networking where users can meet others who are not previous contacts.

It is another object to provide users with a listing of nearby subscribers with common interests and allow the user to pick a contact, thereby enabling opportunistic social networking.

These and other related objects are achieved according to a first embodiment of the invention configured as a system for providing a proximity-based matching notification service. The system generally includes a server, a telecommunications network, and user devices. More particularly, there are one or more central servers having one or more databases for storing profiles and geo-locations of users, and an electronic memory for storing software. The users, via their user devices, can communicate queries and their geo-location to the central server and receive notifications from the central server over the telecommunications network. The software contains a set of instructions for proximity filtering a query and geo-location from one user device to select another user device matching the query and being within a predetermined distance from the geo-location, and issuing a proximity-based matching notification.

The central server includes a registration server, and the database includes a registry database, wherein users' devices communicate with the registry database via the registration server to create an account. The registry database includes a record for each user wherein each record includes fields for storing user profile data and user preference information and the ability to selectively designate fields as public or private.

The software contains a set of instructions to issue a proximity-based matching notification to a user device different than the user device submitting the query. The notification includes only profile data that the one inquiring user designated as public. The software contains a set of instructions to issue a proximity-based matching notification to the one user device, wherein the notification includes only profile data that another user designated as public.

The central server further includes a search server, and the database includes a query and locations database for storing search query data and geo-location data. Search software is stored on the search server, wherein the search software contains a set of instructions for receiving a query and geo-location from one user device and proximity filtering for first matching the query against user profile data stored within said registry database. The software also matches the geo-location against geo-locations data stored within the query and location database to provide outsider, proximity-based social networking. The first matching generates a list of matching users based on a computed match score exceeding a preset threshold, and the second matching comprises monitoring the geo-location of the matching users.

The search software includes a set of instructions to monitor whether a matching user device moves within the predetermined distance of the one inquiring user device. The search software includes a set of instructions to check the profile of the one inquiring user and the matching user on the registry database to determine the notification recipients and content to implement opportunistic social networking.

In an alternate embodiment, the invention provides a method for providing a proximity-based matching notification service. In a first step, one or more central servers are provided that have one or more databases for storing profiles and geo-locations of users and electronic memory for storing software containing a set of instructions for proximity filtering. A telecommunications network is provided. Queries and geo-locations are communicated from a plurality of users having user devices to said central server via the telecommunications network. The communicated query and geo-location from one user device is proximity filtered to select another user device matching the query and being within a predetermined distance from the geo-location. A proximity-based matching notification is then issued and subsequently received at a user device.

The central server comprises a registration server, and the database comprises a registry database wherein prior to said communicating step, the method further includes the step of users devices communicating with said registry database via said registration server to create an account. The registry database includes a record for each user, wherein each record includes fields for storing user profile data and user preference information and the ability to selectively designate fields as public or private.

The proximity filtering step includes issuing a proximity-based matching notification to another user device different than the one user device, wherein the notification includes only profile data that the one user designated as public. The proximity filtering step includes issuing said proximity-based matching notification to the one user device, wherein the notification includes only profile data that another user designated as public.

The central server further comprises a search server, and the database comprises a query and locations database wherein the method further includes the step of storing search query data and geo-location data on the query and location database. Search software is stored on the search server. The method further includes the step of receiving a query and geo-location from one user device and proximity filtering for first matching the query against user profile data stored within the registry database. Outsider proximity-based social networking comprises second matching the geo-location against geo-location data stored within said query and location database. The first matching step generates a list of matching users based on a computed match score exceeding a preset threshold, and the second matching step comprises monitoring the geo-location of said matching users' devices. The step of monitoring determines whether a matching user device moves within the predetermined distance of the one inquiring user device. The method includes checking the profile of the one inquiring user and the matching user on the registry database to determine the notification recipients and notification content to implement opportunistic social networking.

In yet another embodiment, there is no central server in the system. In this case, a user registers and searches all on his own device. Therefore, all users' devices have their profiles and preference settings stored locally on the device itself. In this case, the mobile device of the user doing the search will, via a suitable communications and data transfer protocol, request the enrolled profile directly from the phone of the found party. Once the searcher's device receives the profile, it computes a match score locally, similar to how the server does it as described in the preferred embodiment. If indeed it is a good enough match, then the searcher's phone can send a notification report to the phone of the matched party to facilitate a physical meeting or some other communication between the involved parties. As can be seen in FIG. 9, a first mobile device 150A registers with a profile and preferences on its own device by storing data in Registration 1000A. A search query module 602A sends a request over a network 950 having suitable Communications and Data Transfer Protocol. The second mobile device 150B receives the query and performs analysis with Match Program 604B. The Notification Report module 606B can send a notification report via the network back to first mobile device 150A.

This embodiment would be administered by a system for providing a proximity-based matching notification service generally including a telecommunications network and a group of users having user devices. The proximity-based telecommunications network operates with users located within several hundred meters of the transceivers. The group of users have user devices, each of which include stored profiles and preferences and means for communicating queries and notifications with other user devices via said telecommunications network, and electronic memory for storing software. The software contains a set of instructions for formulating queries to be transmitted and processing received queries to determine match data and issuing a notification report.

The determination of match data provides outsider, proximity-based social networking, where the users need not be prior contacts or friends. The software may contain a set of instructions to generate a list of matching users based on a computed match score exceeding a preset threshold. It should be noted that the proximity based network inherently provides the proximity matching component, since only users within telecommunications range can send or receive queries from other users. The user can select another user from the list to implement opportunistic social networking.

Furthermore, this embodiment could be executed by a method for providing a proximity-based matching notification service between a plurality of user devices. A proximity-based telecommunications network is provided in which users must be within several hundred meters of the transceivers. Each user device is equipped with means to store profile and preference data and means for formulating and communicating queries and notifications with other user devices via said communications network. Next a query is formulated to be transmitted to another user. Received queries are processed to determine match data, and notifications are issued.

The determination of match data provides outsider, proximity-based social networking, where the users need not be prior contacts or friends. The software may contain a set of instructions to generate a list of matching users based on a computed match score exceeding a preset threshold. It should be noted that the proximity based network inherently provides the proximity matching component, since only users within telecommunications range can send or receive queries from other users. The user can select another user from the list to implement opportunistic social networking.

Employing location-based services such as GPS to track the mobile communications device of all active users, any given user can query the system to see if any other registered users or entities are within a specified range and meet a matching criteria previously specified by the given user. If so, the user conducting the search can be notified of the other user(s)' presence and may optionally communicate directly with that person via electronic messaging or physical means.

Therefore, this is a useful tool for meeting both friends and new people who are in the same room or venue who share interests and are carrying with them mobile communication devices such as cell phones, smart-phones, laptop computers, or tablet computing devices and are active users of the present invention. Because it allows strangers and known entities alike to be alerted to each other based on proximity and mutual interest, and whether or not to share contact information based on all parties preferences, it addresses a problem that the prior art does not.

### BRIEF DESCRIPTION OF THE DRAWINGS

The advantages, nature, and various additional features of the invention will appear more fully upon consideration of the illustrative embodiments now to be described in detail in connection with the accompanying drawings. In the drawings wherein like reference numerals denote similar components throughout the views:

FIG. 1A shows an overview of the various components of the present invention as they apply to the registration process.

FIG. 1B shows an overview of the various components of the present invention as they apply to the search and notification process.

FIG. 2A shows the steps a first exemplary user would execute to register with the system.

FIG. 2B shows the steps a second exemplary user would execute to register with the system.

FIG. 3A shows example details of a first exemplary user's profile information.

FIG. 3B shows example details of a second exemplary user's profile information.

FIG. 4A shows example details of a first exemplary user's preferences.

FIG. 4B shows example details of a second exemplary user's preferences.

FIG. 5A shows the steps a first exemplary user would execute to enter a search query into the system.

FIG. 5B shows the steps a second exemplary user would execute to enter a search query into the system.

FIG. 6A shows an example of a first exemplary user's search query.

FIG. 6B shows an example of a second exemplary user's search query.

FIG. 7 shows details of the search server, including a flow diagram of the search process.

FIG. 8A shows an example of the notification report sent to a first exemplary user when another interesting user or users are found.

FIG. 8B shows an example of the notification report sent to a second exemplary user when found by a first exemplary user.

### DETAILED DESCRIPTION OF THE INVENTION

What is needed is a new invention that can let people know automatically and immediately when a person or entity of interest has come within a predetermined physical range and meets some predetermined matching criteria. This invention describes a method of automatically notifying people if they are within the proximity of other people or entities of interest to them (referred to as “matched parties”) whether or not they have any prior knowledge of or relationship with that person or entity. In this way, the invention differs from typical social networking prior art, which typically requires the manual establishment of a relationship first before sharing location details.

The present invention provides a method of and system for automatically notifying registered users if they are within the proximity of other registered persons or entities of interest to them, whether or not they have any prior knowledge of or relationship with that person or entity. All parties have control over whether notifications are sent to other party or parties. Employing location-based services such as GPS to track the mobile communications device of all active users, any given user can query the system to see if any other registered users or entities are within a specified range and meet a matching criteria previously specified by the given user. If so, the user conducting the search can be notified of the other user(s)' presence and may optionally communicate directly with that person via electronic messaging or physical means.

Therefore, this is a useful tool for meeting both friends and new people who are in the same room or venue who share interests and are carrying with them mobile communication devices such as cell phones, smart-phones, laptop computers, or tablet computing devices and are active users of the present invention. Because it allows strangers and known entities alike to be alerted to each other based on proximity and mutual interest, and whether or not to share contact information based on all parties preferences, it addresses a problem that the prior art does not.

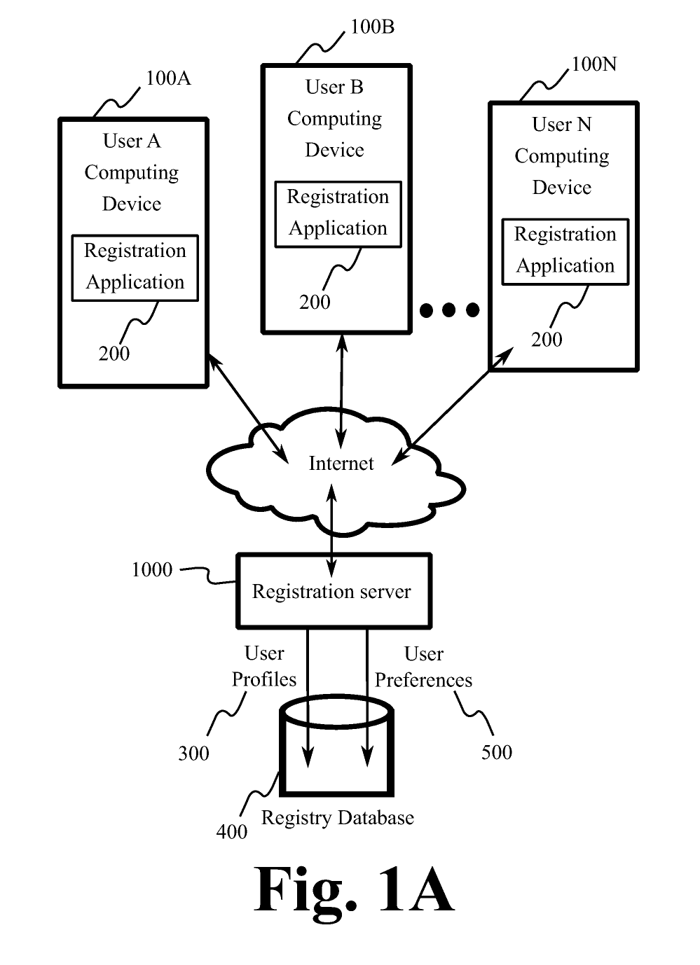

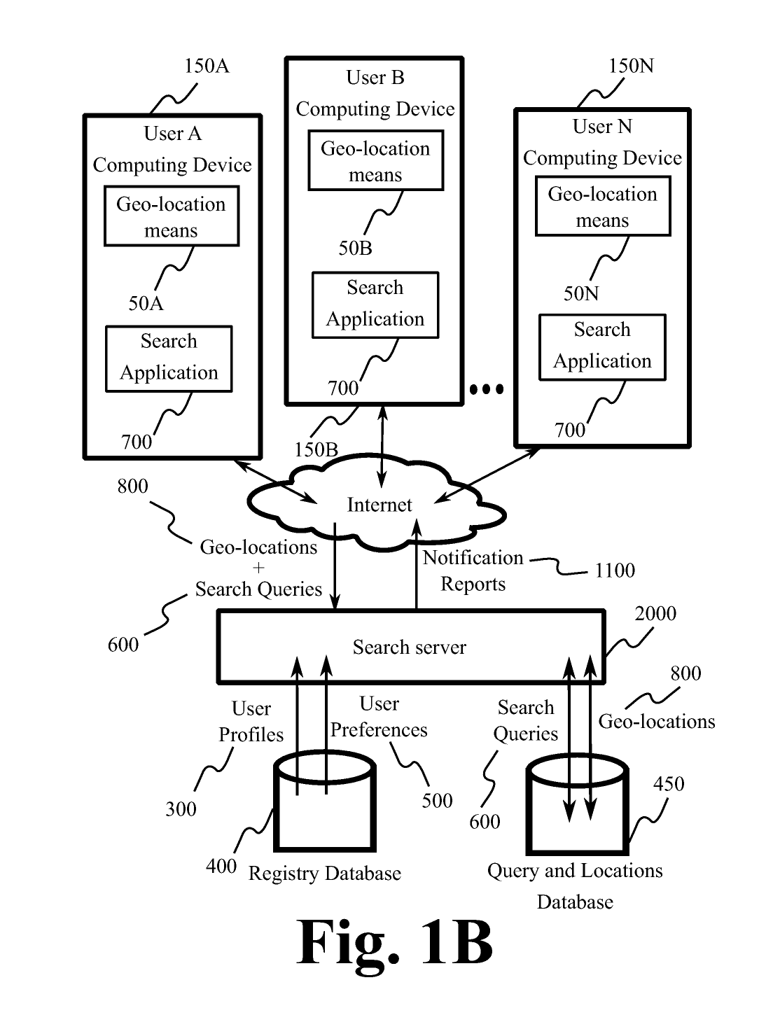

In a high-level description of the invention, referring to FIG. 1A, in the preferred embodiment a multitude of users (100A, 100B, . . . 100N) must first register for the notification service by running registration application 200 on their computing devices (e.g. desktop PC, cell phone, smartphone, notebook computer, etc.) which have internet access or are otherwise network-able to the system registration server 1000. The registration process results in profile information 300 and preferences 500 to be stored in a database 400. Each user maintains an account within the proximity based matching system. The account may be physically configured as a record within the registry database. The database in the preferred embodiment is non-volatile memory such as a computer hard drive, but could be any type of persistent computer memory. Reference numeral 300 refers to profile information generally. The profile information of User A will be designated as 300A, while the profile information of User B will be designated as 300B. Reference numeral 500 refers to user preferences generally. The user preferences of User A will be designated as 500A, while the user preferences of User B will be designated as 500B.

Referring to FIG. 1B, registered users may next search for other users of interest to them by executing the Search Application 700 on their computing devices (e.g. cell phone, smartphone, notebook computer, etc.) which have internet access or are otherwise network-able to the system search server 2000. The computing devices, if they are handheld and mobile, must have a means for knowing where they are located, referred to as “geo-location” capability. The Global Positioning System (GPS) is used in the preferred embodiment as the means of geo-location in the computing devices, as it is found in most cell phones in the United States. It is possible for each user's communication device to have a different means of geo-location. Geo-location means are generally referred to as reference numeral 50. The geo-location means of User A is designated as 50A, while the geo-location means of User B is designated as 50B.

Geo-location means may also be provided manually by the user himself (“I′m at the Redwood Mall in Brooklyn, N.Y.”), which may be mapped to geo-physical coordinates by the search server 2000 using techniques well known in the art, such as Google Maps.

The user enters a search query 600 by specifying the search criteria, including a proximity range. A search query is generally referred to as reference numeral 600. A search query by User A is designated as 600A, while a search query by User B is designated as 600B. If a suitable match or matches are found to be within the specified proximity range, the user and the matched party or parties may be notified by the system via Notification Reports 1100 (i.e. Report 1100A to User A, Report 1100B to User B, etc.) and thereby given information about each other to facilitate meeting or other subsequent activities. Up-to-date location information 800 (location information 800A for User A, location information 800B for User B, etc.) for all users is stored in search database 450 so it can be used as a field in the search. The search criteria is also stored in database 450 in case it is useful in the future. In the preferred embodiment, the registry database 400 and the search database 450 are different entities, but those skilled in the art will appreciate that is possible to make them the same entity as well.

Similarly, a multitude of other users may also be actively searching at the same time or simply actively using the system in the hopes of being found by another user. For example, User B, using a second computing device 150B with geo-location means 50B, may perform a search at the same time as User A. Yet a third user, for example User N, using a third computing device 150N with geo-location means 50N, may not be searching but may still be found as the result of a search by a different user. Any registered user with sufficient profile information may perform a search at any time of his or her choosing and may be listed as the result of a search, even if they are not actively searching themselves.

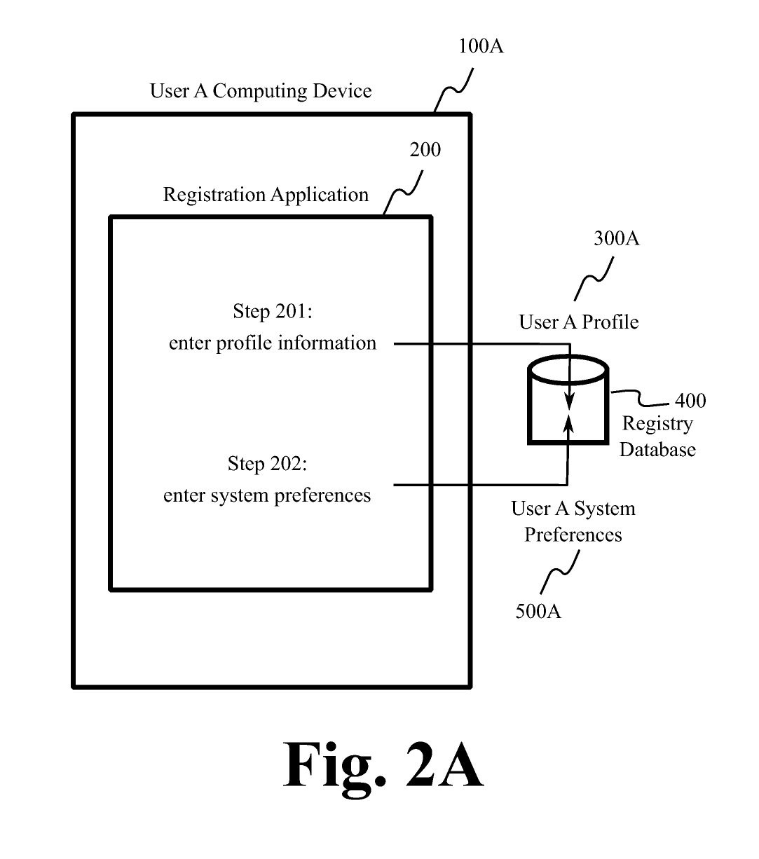

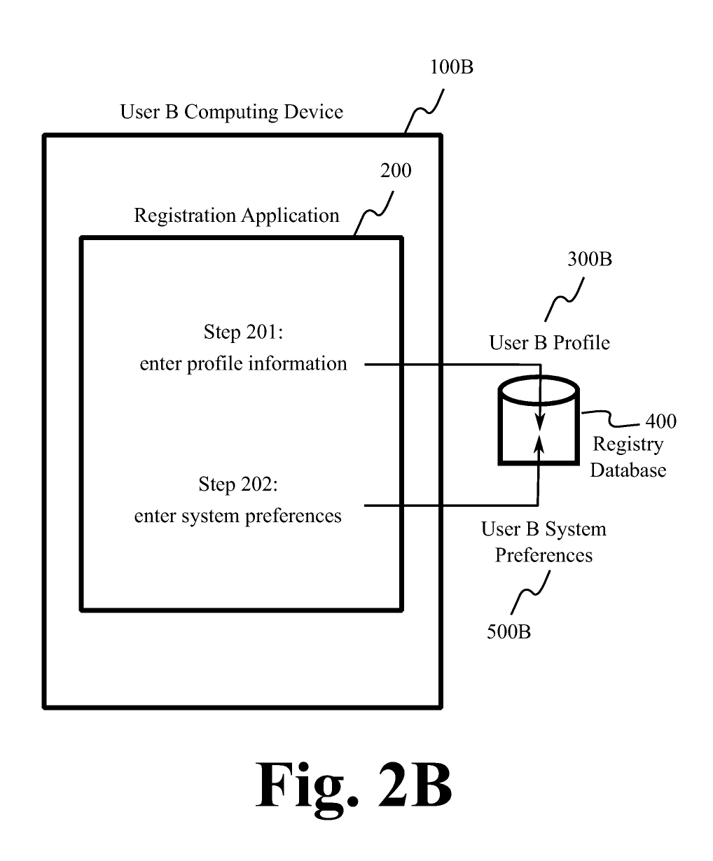

In a more detailed description of the invention, referring to FIG. 2A, by executing the registration application 200 on computing device 100A, a first user, referred to for illustrative purposes as User A, enters his profile 300A, where it is stored in database 400 for later use. The registration application 200 can be any general application such as a web browser that connects via the internet to a website running on the registration server 1000. However, the application could be more specific and use a custom-design graphical interface rather than a website. Optionally, other means of registration such as text message, paper mail, and telephone can be used.

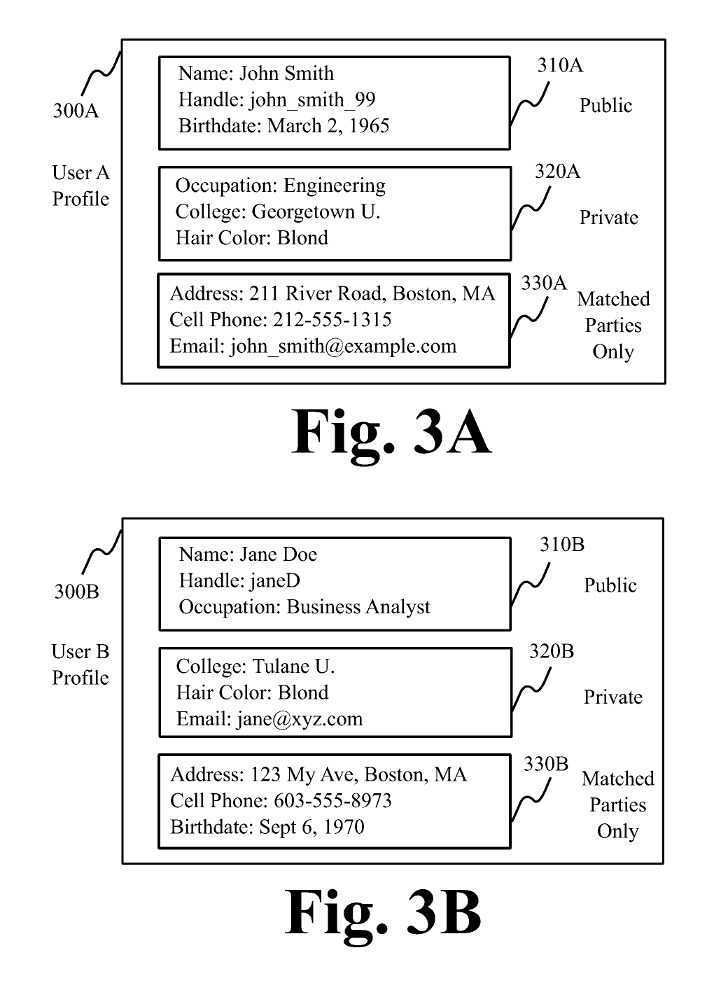

Referring to FIG. 2A, at the time of registration, in Step 201 User A is prompted to enter his profile information 300A. This profile contains pertinent information about the corresponding user such as name (“example: John Smith”) or nickname/handle (“example: john_smith_{—}99”), birth date, age, gender, interests, education, favorite places and things, political affiliation, etc. It may also contain a picture of the user and contact information such as cell phone number and e-mail address. As shown in FIG. 3A, parts 310A of a given profile may be designated for public view, while other parts 320A can be designated by the user as private. Still other parts 330A (referred to as “matched party parts”) might be deemed viewable only to those users or entities of interest to User A. Note that computing device 100A may be any computer and need not be the one 150A subsequently used to conduct the search. Therefore, the computing devices used for registration need not have any geo-location capability, while those for searching must.

Public parts—otherwise known as fields—of the profile will always be viewable by matched parties and can be used as fields for the search query. Private parts of the profile are used as part of the match criteria, but are not available for view by any other parties, matched or not. Matched party parts may also be used as fields of the query, but are made available only to matched parties. The profile may be filled out, in whole or in part, with default values specified by the system, during initial registration. However, the profile may be updated and/or expanded by the user at any time, and parts of it may be automatically updated by the system, such as age.

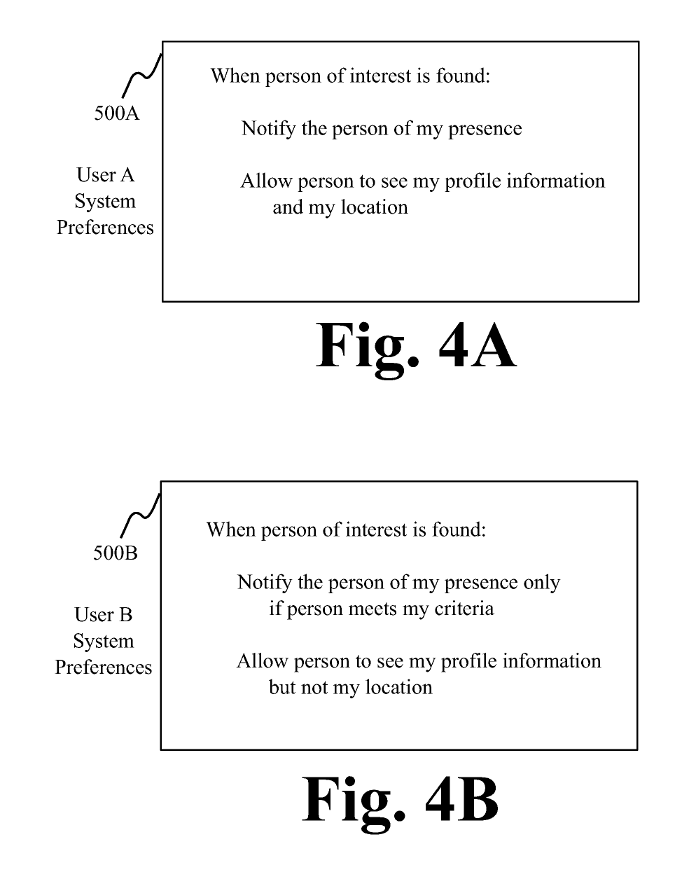

Referring again to FIG. 2A, at the time of registration, or at a later date, in Step 202 User A will also select a set of system preferences 500A that govern how the system behaves for them. FIG. 4A shows some examples of preferences a user may choose. In this case, User A chooses to have matched parties notified of his presence in all cases and to allow the matched party or parties to see those parts 310A and 330A of his profile and to see his geographic location. It will be understood by anyone skilled in the art that the list of possible preferences is great and is not in any way limited to what is described herein. Preferences may consist of many other items, depending on system complexity and flexibility, and may be specific to circumstances and conditions. For example, the system may behave differently when the user is in a different location (e.g., at home, at work, or in neither place) and could also be specific to the search criteria.

In the preferred embodiment the user will select an initial set of preferences until or unless the user selects something different at a later date. In an alternate embodiment, default preferences are used initially.

In a separate transaction or transactions, other users go through a similar registration process. A second user, referred to as User B for illustrative purposes, also registers for the service, as shown in FIG. 2B. User B executes registration application 200 on his computing device 100B. In Step 201 User B enters her profile information 300B, and in Step 202 she enters her system preferences 500B. The profile and preference information are stored in database 400 for later use. Referring to FIG. 3B, User B may designate public parts 310B, private parts 320B, and parts 330B to be shown only to matched parties. FIG. 4B shows that User B has different preferences than does User A. Here, preferences 300B show an example in which the user will only allow her profile information and presence to be made known to other users who find her if and only if those users also match her criteria. That is, if both User B and another user are mutually interested in each other, then and only then would the other users be made aware of User B's presence. When that is the case, User B has chosen to make parts 310B and 330B of his profile, but not his location, available to other users.

Typically, a multitude of users register for the service. A minimum of at least two users or entities must register with the system for the invention to be useful. So, referring again to FIG. 1A, a User N would use computing device 100N to register for the service. The process is similar to that of other users, but the individual profile information and preferences are personal and, when taken as a whole, likely to be unique for a given user.

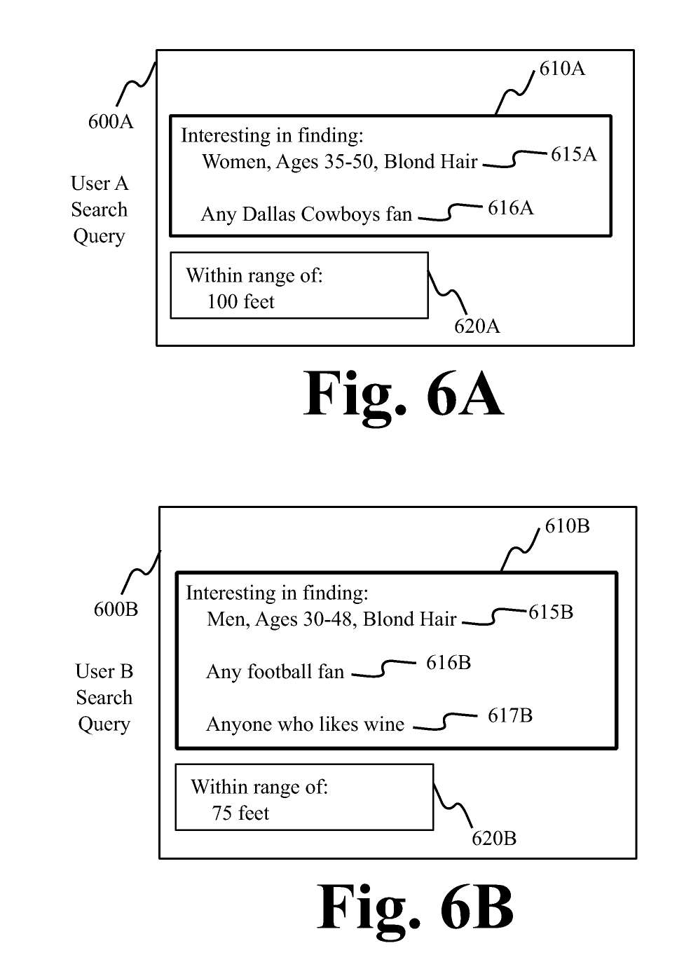

Referring to FIG. 1B, once registered with some stored profile information, User A may now search for parties of interest within a specified proximity range. To do this, he executes search application 700 on his mobile phone or other computing device 150A with global positioning means 50A to select parameters 600A of an automatic search for “interesting” people who may be nearby. Referring to FIG. 6A, the search query 600A may be completely arbitrary and, in the preferred embodiment, contains criteria consisting of a set of allowable values or ranges of values 610A for some or all of the fields available in the profile. This set contains specific ranges and allowable values such as those in 615A and 616A for each specified field. The search query 600A also includes proximity range 620A wherein the user selects the range of proximity he is interested in for the current search (e.g., within 75 feet or within 1 mile). Similarly, referring to FIG. 6B, a second user, User B, may conduct a search concurrently with User A or not with his own set of search parameters 600B, consisting of allowable values and ranges of values 610B containing specific ranges 615B, 616B and 617B, and a proximity range of interest 620B. The search query 600A could also be more generalized so as to allow for arbitrary search queries as one would type them into a search engine such as Google or Yahoo. For example, User A can opt to be notified of everyone within a range of 100 feet and whose profile contains the terms, “baseball” and “apple pie.” The keywords could be completely arbitrary.

In an alternate embodiment, users may select one or more of a broad set of query criteria from a predefined list. For example, selecting “Business” will notify User A of all users that work in the same field or industry or have the same title as User A. Selecting “Romantic” would notify User A of anyone the server calculates might be a good romantic match for him. A “Shopping” option might allow for matches to interesting stores that he passes by. In yet another embodiment, the search application simply provides all relevant matches using all the available profile information without the need to enter specific search criteria, but using default search parameters. This makes searching as simple as possible from the user's standpoint.

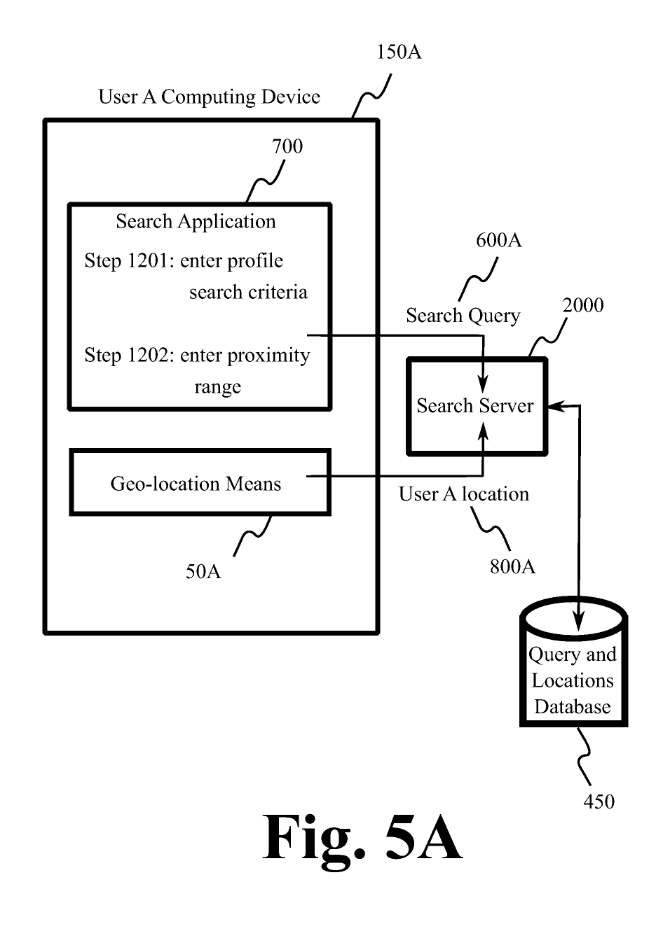

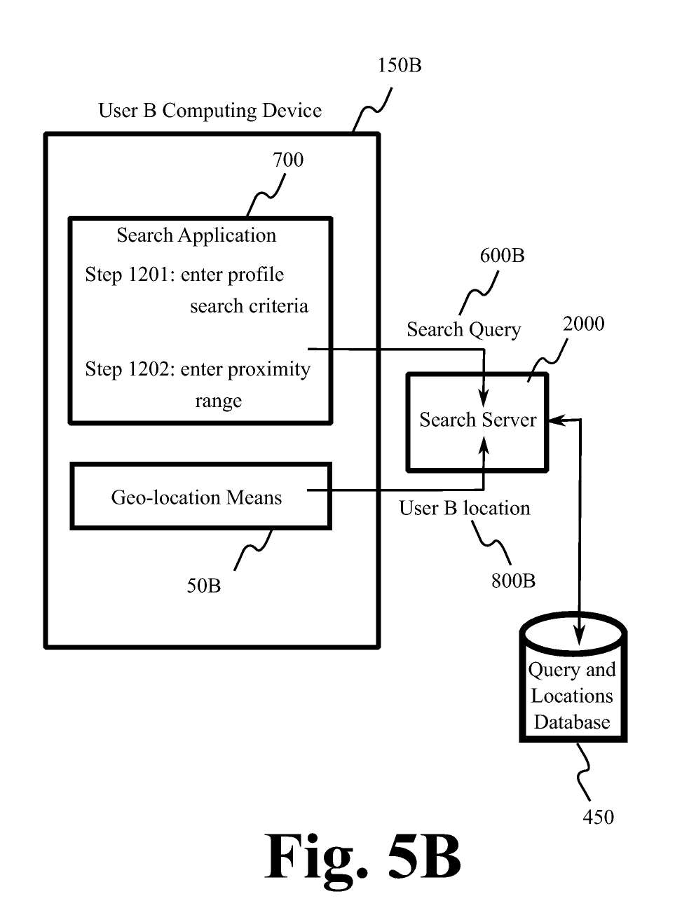

In the preferred embodiment, referring to FIG. 5A, User A's mobile computing device 150A continuously sends search server 2000 updates to his geo-location 800A so that the system can effectively track his whereabouts. In addition, all other registered users' mobile handsets are tracked in similar ways. Note that location is in the form of latitude and longitude decimal degrees, but other equivalent mapping coordinates could also be used.

The server, having up-to-date geo-location data on each active user, then determines that another handset 150B, shown in FIG. 5B, belonging to User B, in location 800B, and having geo-location means 50B, is within physical range (as defined by the user or a default setting).

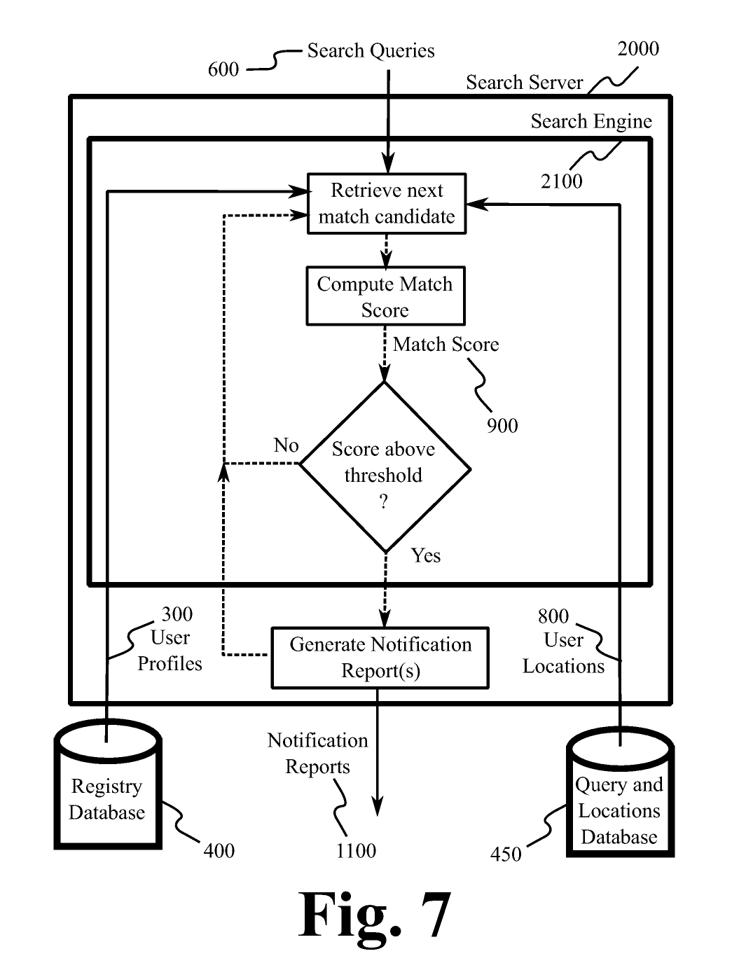

Referring to FIG. 7, the search server 2000 receives the search queries/criteria 600 and executes the search engine logic 2100. For each query received, the search engine tests the matching criteria 600 against the profiles 300 of other users in the Registry Database 400, as well as the latest user location information 800 in the Query and Locations Database 450. For each user in the registry, this results in a match score 900 that relates to the goodness of the match of the searching user to a given user in the database. The score could be computed using standard statistical techniques well known in the art, incorporating pattern recognition or other matching techniques. Fields to be matched may be weighted differently or equally depending on user preference or default settings. In other embodiments the score could be a binary “match (1)/no match (0)” result. The “matching users” are determined by a computed match score of 900 that exceeds a preset threshold. Note also that it is possible to first generate a list of matching users that match User A's criteria and then wait to see if they come within the physical range required for notification.

If a match score is above a predetermined threshold and the physical location of the matching user or users is within the specified proximity range, the server then checks each matched user's preferences to decide which, if any, parties should be notified of the match. If user preferences permit notifying one or more parties that a match was found, then the search server sends message(s) 1100 to the user who conducted the search, as well as to parties found as a result of the search, depending on the preferences of both the querying party and each matched party.

The use of a search engine to compute a match score is a form of social networking. However, in traditional social networking environments, the interaction between users is controlled by the second user accepting the first user as a friend. In contrast, the method and system according to the invention involves matching users based on mutual interests, as reflected in the match score. This allows strangers or outsiders to be matched up. The ability to meet an outsider is driven by the one user requesting to meet with somebody having mutual interests and who is nearby. Accordingly, we define “outsider proximity-based social networking” as a process for matching strangers based on mutual interest and co-location; that is, two entities occupying the same location.

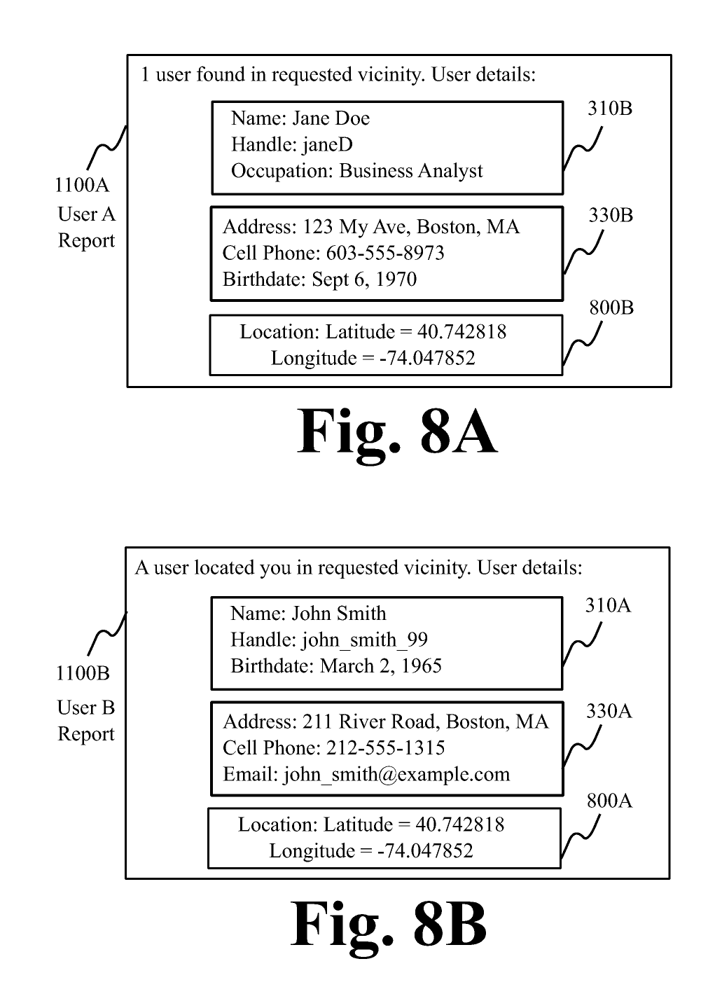

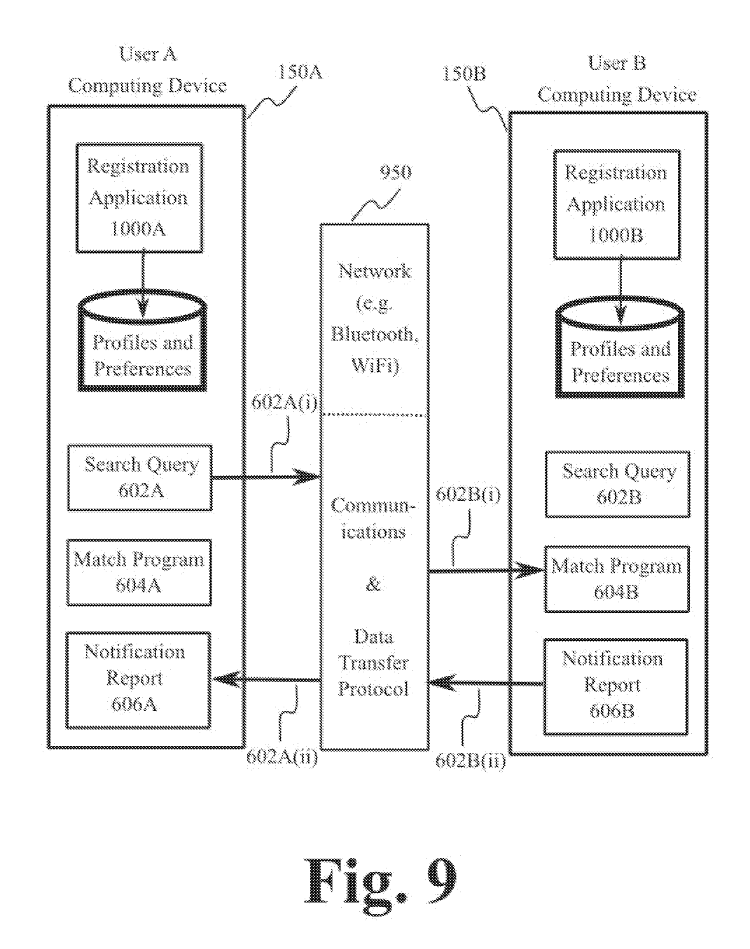

Continuing the example and referring to FIG. 8A, User A is notified and receives a report 1100A containing some basic information about User B, specifically parts 310B and 330B, depending on the preferences 500B that User B specified during registration or at a later date. The report 1100A also contains the physical location 800B of User B. User A may, at that time, try to meet User B or take any other action User A deems appropriate. This may be accomplished any number of ways. For example, if User A has the cell phone number of User B, he may call her or send a text message. If User A has a picture of User B and a location, he may be able to find her. If he has a name or handle, he might simply shout it out and hope User B responds in kind. It is also possible for a relative location to be part of the report instead of, or in addition to, the absolute physical location. For example, the report could state that, “User B is located 50 feet west and 12 feet north of your present location.”

In this example, User B is notified via report 1100B that User A has been informed of his presence, depending on his preferences, as shown in FIG. 8B. However, in some cases, User B is not made aware of this; in other cases, User A decides whether User B is notified; and in still other cases User B may only allow User A to be notified of his presence if, in addition to User B matching User A's criteria, User A matches User B's criteria. Report 1100B will, therefore, contain profile parts 310A and 330A and may contain User A's location 800A and/or a relative version of it. Optionally, the report to User B may contain the search criteria User A entered to find her.

Note that if more than one user is in range of a user and meets the criteria, the same process can be carried out for each one, or a summarized version may be reported that lists all the matching users with details hidden until and unless the user indicates he wishes to see them. The user is then able to select the person or persons that he wishes to reveal his location or profile to. Thus, a user can select a person for a social interaction or a business interaction. We refer to this selection ability as “opportunistic social networking.” It should be noted that this type of social networking is not a friend-based network, but rather one based on mutual interest and being located near each other. As can be appreciated, the co-location aspect is totally random and allows subscribers or users to meet others that they would not have reached through traditional friend-based networking.

Another aspect of the invention is that the information available to Users A and B, once a match has been detected, is settable either by the user and/or by the service. This means that it is possible, depending on the service level a user has access to, that more and/or higher quality information may be made available to him when a match is encountered. Thus, for example, User A may pay a higher fee to the service to be notified of User B's presence regardless of User B's settings, thus thwarting the wishes of User B.

Another aspect of the invention relates the actions taken once two or more users have been matched. In the preferred embodiment, enough information is given in the user report to facilitate locating other users and introducing themselves. This could range from pictures of the other parties to mapping out physical directions to reach them, initiating a phone call between them, or playing special ringtones on all the computing devices. The actions taken by the system are dependent on the users' personal preferences, the specific profile information they make available, and the capabilities of their individual communication devices.

An alternate embodiment uses a local peer-to-peer architecture rather than a central server-based approach for determining which users are within physical range. In this case, a first mobile handset with local networking capability (for example, Bluetooth, WiFi Direct, etc.) can discover that a second handset, also with local network capability and compatible with the first, is within proximity based on the fact that both are in network range. For Bluetooth this typically means 10 meters, depending on the device class; and for WiFi this range could be 100 meters or more. Modern networking standards allow for discovery of compatible devices within range. In this case, the ability to filter on proximity is limited to a binary result: another device is either within network range or it is not. In this embodiment, the registration server is unchanged from the preferred embodiment, but the search server no longer needs to do the location filtering or to receive and store location updates from active users. As can be seen in FIG. 9, a first mobile handset 150A is provided with local networking capability. The network 950 may be selected from a local area Network, a wide area Network, a Bluetooth network, a WiFi Direct Network, or any other Network now in existence or developed in the future with suitable capabilities. Proximity-based matching is performed by having handset 150A contact another handset 150B which is in wireless communication range.

In yet another embodiment, there is no central server in the system. In this case, a user registers and searches all on his own devices. Therefore, all users' devices have their profiles and preference settings stored locally on the device itself. In this case, the mobile device of the user doing the search will, via a suitable communications and data transfer protocol, request the enrolled profile directly from the phone of the found party. Once the searcher's device receives the profile, it computes a match score locally, similar to the way the server does it as described in the preferred embodiment. If indeed it is a good enough match, then the searcher's phone can send a notification report to the phone of the matched party to facilitate a physical meeting or some other communication between the involved parties. As can be seen in FIG. 9, a first mobile device 150A registers with a profile and preferences on his own device by storing data in Registration 1000A. A search query module 602A sends a request over a network 950 having suitable Communications and Data Transfer Protocol. The second mobile device 150B receives the query and performs analysis with Match Program 604B. The Notification Report module 606B can send a notification report via the network back to first mobile device 150A.

This embodiment would be administered by a system for providing a proximity-based matching notification service comprising:
a proximity-based telecommunications network in which users must be within several hundred meters of the transceivers; and
a plurality of users having user devices, each of which include (i) stored profiles and preferences and (ii) means for communicating queries and notifications with other user devices via said telecommunications network, and (iii) electronic memory for storing software; and
wherein said software contains a set of instructions for formulating queries to be transmitted and processing received queries to determine match data and issuing a notification report.

The determination of match data provides outsider, proximity-based social networking in which the users need not be prior contacts or friends. The software may contain a set of instructions to generate a list of matching users based on a computed match score exceeding a preset threshold. It should be noted that the proximity based network inherently provides the proximity matching component, since only users within telecommunications range can send or receive queries from other users. The user can select another user from the list to implement opportunistic social networking.

Furthermore, this embodiment could be executed by a method for providing a proximity-based matching notification service between a plurality of user devices comprising the steps of:

providing a proximity-based telecommunications network in which users must be within several hundred meters of the transceivers;

equipping each user device with (i) means to store profile and preference data and (ii) means for formulating and communicating queries and notifications with other user devices via said communications network;

formulating a query to be transmitted to another user;

processing received queries to determine match data; and

issuing notifications.

The determination of match data provides outsider, proximity-based social networking in which the users need not be prior contacts or friends. The software may contain a set of instructions to generate a list of matching users based on a computed match score exceeding a preset threshold. It should be noted that the proximity based network inherently provides the proximity matching component, since only users within telecommunications range can send or receive queries from other users. The user can select another user from the list to implement opportunistic social networking.

While certain details have been shown and described with respect to hardware, system, and process steps, it should be understood that other options and variations may be incorporated within the spirit of the invention. Various storage devices, computer systems, software applications, and telecommunications links may be used. The items of information can be captured by a variety of devices and communicated to the private servers by all current and future telecommunications means. The elements shown in the figures may be implemented in various forms of hardware, software, or combinations thereof. Preferably, these elements are implemented in software on one or more appropriately programmed general-purpose digital computers having a processor and memory and input/output interfaces.

Implementations of the present principles can take the form of an entirely hardware embodiment, an entirely software embodiment, or an embodiment including both hardware and software elements. Certain aspects of the present invention involving data processing, sorting, comparing, and identification steps are implemented in software, which includes but is not limited to firmware, resident software, microcode, etc.

The present principles may be implemented and can take the form of a computer program product accessible from a computer-usable or computer-readable medium providing program code for use by or in connection with a computer or any instruction execution system. For the purposes of this description, a computer-usable or computer readable medium can be any apparatus that may include, store, communicate, propagate, or transport the program for use by or in connection with the instruction execution system, apparatus, or device. The medium can be an electronic, magnetic, optical, or semiconductor system (or apparatus or device). Examples of computer-readable media include a semiconductor or solid state memory, magnetic tape, a removable computer diskette, a random access memory (RAM), a read-only memory (ROM), a rigid magnetic disk, and an optical disk. Current examples of optical disks include compact disk-read only memory (CD-ROM), compact disk-read/write (CD-R/W), and DVD.

A data processing system suitable for storing and/or executing program code may include at least one processor coupled directly or indirectly to a server and memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers. Network adapters may also be coupled to the system to enable the data processing system to become coupled to other data processing systems or remote printers, servers, or storage devices through intervening private or public networks. Modems, cable modems, and Ethernet cards are just a few of the currently available types of network adapters.

Having described preferred embodiments for processes, apparatus, and systems used therein for providing a proximity-based matching notification service (which are intended to be illustrative and not limiting), it is noted that modifications and variations can be made by persons skilled in the art in light of the above teachings. The invention may be embodied in other specific forms without departing from its spirit or essential characteristics. The described examples are to be considered in all respects only as illustrative and not restrictive. The scope of the invention is, therefore, indicated by the appended claims rather than by the foregoing description. All changes which come within the meaning and range of equivalency of the claims are to be embraced within their scope. Having thus described the invention with the details and particularity required by the patent laws, what is claimed and desired protected by Letters Patent is set forth in the appended claims.

What is claimed is:

1. A system for providing a proximity-based matching notification service comprising:
one or more central servers having (i) one or more databases for storing profiles and geo-locations of users and (ii) electronic memory for storing software;
a telecommunications network; and
a plurality of users having user devices capable of communicating queries and geo-location to said central server via said telecommunications network and receiving notifications from said central server;
wherein said software contains a set of instructions for proximity filtering a query and geo-location from one user device to select another user device matching the query and being within a predetermined distance from the geo-location, and issuing a proximity-based matching notification.

2. The system of claim 1 wherein said central server comprises a registration server and said database comprises a registry database wherein users' devices communicate with said registry database via said registration server to create an account.

3. The system of claim 2 wherein said registry database includes a record for each user wherein each record includes fields for storing user profile data and user preference information and the ability to selectively designate fields as public or private.

4. The system of claim 3 wherein said software contains a set of instructions to issue said proximity-based matching notification to a user device different than the one user device wherein the notification includes only profile data that the one user designated as public.

5. The system of claim 3 wherein said software contains a set of instructions to issue said proximity-based matching notification to the one user device wherein the notification includes only profile data that another user designated as public.

6. The system of claim 3 wherein said central server further comprises a search server and said database comprises a query and locations database for storing search query data and geo-location data.

7. The system of claim 6 further comprising search software stored on said search server wherein said search software contains a set of instructions for receiving a query and geo-location from one user device and proximity filtering for first matching the query against user profile data stored within said registry database and second matching the geo-location against geo-location data stored within said query and location database to provide outsider, proximity-based social networking.

8. The system of claim 7 wherein said first matching generates a list of matching users based on a computed match score exceeding a preset threshold and said second matching comprises monitoring the geo-location of said matching users.

9. The system of claim 8 wherein said search software includes a set of instructions to monitor whether a matching user device moves within the predetermined distance of said one user device.

10. The system of claim 9 wherein said search software includes a set of instructions to check the profile of said one user and said matching user on said registry database to determine the notification recipients and content to implement opportunistic social networking.

11. A method for providing a proximity-based matching notification service comprising the steps of:
providing one or more central servers having (i) one or more databases for storing profiles and geo-locations of users and (ii) electronic memory for storing software containing a set of instructions for proximity filtering;
providing a telecommunications network;
communicating queries and geo-locations from a plurality of users having user devices to said central server via said telecommunications network;
proximity filtering a communicated query and geo-location from one user device to select another user device matching the query and being within a predetermined distance from the geo-location and issuing a proximity-based matching notification; and
receiving notifications from said central server at a user device.

12. The method of claim 11 wherein said central server comprises a registration server and said database comprises a registry database and wherein, prior to said communicating step, the method further includes the step of users' devices communicating with said registry database via said registration server to create an account.

13. The method of claim 12 wherein said registry database includes a record for each user wherein each record includes fields for storing user profile data and user preference information and the ability to selectively designate fields as public or private.

14. The method of claim 13 wherein said proximity filtering step includes issuing a proximity-based matching notification to another user device different than the one user device wherein the notification includes only profile data that the one user designated as public.

15. The method of claim 13 wherein said proximity filtering step includes issuing said proximity-based matching notification to the one user device wherein the notification includes only profile data that another user designated as public.

16. The method of claim 13 wherein said central server further comprises a search server and said database comprises a query and locations database wherein the method further includes the step of storing search query data and geo-location data on the query and location database.

17. The method of claim 16 further comprising search software stored on said search server, said method further including the step of receiving a query and geo-location from one user device and proximity filtering for first matching the query against user profile data stored within said registry database and outsider proximity-based social networking comprising second matching the geo-location against geo-location data stored within said query and location database.

18. The method of claim 17 wherein said first matching generates a list of matching users based on a computed match score exceeding a preset threshold, and said second matching comprises monitoring the geo-location of said matching users' devices.

19. The method of claim 18 wherein the method includes the step of monitoring whether a matching user device moves within the predetermined distance of said one user device.

20. The method of claim 19 wherein the method includes checking the profile of said one user and said matching user on said registry database to determine the notification recipients and content to implement opportunistic social networking.
